(19) United States
(12) Patent Application Publication
(10) Pub. No.: US 2018/0209540 A1
(43) Pub. Date: Jul. 26, 2018

(54) PISTON RING

(71) Applicant: FEDERAL-MOGULL BURSCHEID GMBH, BURSCHEID (DE)

(72) Inventors: JURGEN GILLEN, LEVERKUSEN (DE); EUGEN WOLFRAM, SOLINGEN (DE)

(21) Appl. No.: 15/745,535

(22) PCT Filed: Jun. 16, 2016
(86) PCT No.: PCT/EP2016/063882

§ 371 Date: Jan. 17, 2018

(30) Foreign Application Priority Data
Jul. 17, 2015 (DE) 10 2015 111 672.3

(51) Int. Cl. F16J 9/20; F16J 9/14; F16J 9/26

(52) U.S. Cl. CPC F16J 9/206; F16J 9/26; F16J 9/14

(57) ABSTRACT

The invention relates to a piston ring of a reciprocating piston internal combustion engine, comprising a ring body with an open abutment, a radially outer running surface side, a radially inner circumferential side, two axially opposite flank sides, an at least partial coating (B) on the running surface side, and a circumferential recess (A) in the lower region of the running surface, said recess ending outside of the abutment region (C). The running surface side has a spherical profile with a pivot point which is arranged at a height h₂<i/> of 55-80% of the axial height h of the piston ring.

The present invention relates to an improved piston ring of a reciprocating internal combustion engine, in particular a top ring with an optimised design.

As a result of the engine-generated pressure loading on the top ring and taking account of the piston deflection under ignition pressure, axial wear occurs on the piston grooves and piston ring flanks. The wear pattern is characterised by increased wear on the outer diameter. Here the contact point between piston ring and cylinder surface migrates ever further into the upper region of the running surface. As a result of the hydrodynamic effects, the scraping action of the top ring decreases in the downward movement (the scraping edge is lifted off the cylinder wall), the lubricating oil remains on the cylinder wall and the oil consumption increases.

The prior art is an asymmetrical crown or minute shape on the running surface of the piston ring. The location of the vertex (also referred to as the pivot point) of these piston rings is defined in ISO 6623: 2004, and is located below the piston ring centre of gravity; The distance of the vertex from the top flank is greater than half the height of the piston ring, or in other words the vertex is located below the vertical centre of the piston ring.

### BRIEF DESCRIPTION OF THE INVENTION

In accordance, with the present invention, a piston ring of a reciprocating internal combustion engine is provided with the features of claim 1; preferred embodiments are defined in the dependent claims.

In accordance with a first aspect of the invention, a piston ring of a reciprocating internal combustion engine is provided, comprising:
an annular body with an open joint, a radially-outer running face, a radially-inner circumferential face and two axially opposed flank faces;
an at least partial coating on the running face; and
a circumferential recess in the lower region of the running surface, which ends ahead of the joint region;

wherein the running face has a crowned profile with a pivot point that is arranged at 55-80% of the axial height of the piston ring.

The pivot point is thus located above the centre (in the axial direction) of the piston ring. By means of this specific displacement of the vertex point or pivot point position in the direction of the upper annular flank (top flank), a reduction of the loading on the lower flank of the piston ring on the outer diameter can be achieved compared with known piston rings with a pivot point below the centre. Because of the forces acting on the piston ring during engine operation, a clockwise rotation is induced, whereas a conventional piston ring with a pivot point below the centre has the tendency to rotate in an antockwise sense. The inventive piston ring therefore effects an improved oil stripping action and reduced wear.

In order to avoid the build-up of a hydrodynamic pressure below the vertex, which lifts the oil stripping edge from the cylinder wall, a specific shaping in the form of the circumferential recess is provided. In order to keep blow-by losses as low as possible, the recess ends at a certain distance ahead of the joint, so that there is no recess in the joint region.

In accordance with one embodiment, the joint region extends over a range of 0.003-0.2% of the circumferential length of the piston ring, in each case outward from the joint. Or in other words, the recess starts at a distance from the joint that corresponds to 0.003-0.2% of the circumferential length of the piston ring.

In accordance with one embodiment, the pivot point of the crowned running surface profile is arranged at 60-70% of the axial height of the piston ring. This embodiment is particularly suitable for piston rings with a small axial height, somewhat less than 3 mm.

In accordance with one embodiment, the radially-inner circumferential face has a substantially symmetrical profile with respect to the axial centre. In a simple embodiment, the inner circumferential face is essentially flat in cross-section,

In accordance with one embodiment, the axial height of the ring is at least 3 mm.

In accordance with one embodiment, the radial depth of the recess runs out ahead of the joint region.

In accordance with one embodiment, the coating (B) on the running face covers or reveals the pivot point. Thus, the piston ring is in contact with the vertex either on the coating applied thereto, or alternatively is in contact with the body exposed there with the cylinder running surface. The coating can be applied physically or galvanically.

### BRIEF DESCRIPTION OF THE FIGURES

FIG. 1 shows a conventional piston ring in cross-section;

FIG. 2 shows schematically a first embodiment of a piston ring in accordance with the invention in cross-section;

FIG. 3 shows a first region of a piston ring in accordance with the invention in cross-section;

FIG. 4 shows second region of a piston ring in accordance with the invention in cross-section;

FIG. 5 shows a first region of a further embodiment of a piston ring in accordance with the invention in cross-section;

FIG. 6 shows a second region of the piston ring of FIG. 5 in cross-section; and

FIG. 7 shows a plan view of the joint region of a piston ring in accordance with the invention.

### DETAILED DESCRIPTION OF THE INVENTION

FIG. 1 shows a conventional piston ring in accordance with the known prior art in a cross-sectional view. The situation shown is that during the downward movement of the piston in the power stroke of the engine concerned. A force F₁ results from the action of the combustion gases, mainly at the outer diameter of the piston ring. This creates a moment M₁ in the anti-clockwise sense.

The gas force F₂ generated by the combustion of the fuel is applied behind the piston ring, i.e. on the radially-inner circumferential face. From a physical point of view, the surface force acts as a single force on the centroid of the axial ring height (see F₂) with a flat inner face, i.e. approximately in the centre of the same. Another force F₃, which is also caused by the combustion gases, is applied on the inner diameter of the piston ring and generates a moment M₃ in the anti-clockwise sense.

In the prior art the counter-force (see F₄) is applied below the centroid X₅, owing to the location of the pivot point in the lower region; this leads to a moment M₅ in the anti-clockwise sense, and additionally applies the reaction force Fₖ to the piston ring at the point of contact with the lower piston groove. This leads to increased flank wear on the outer diameter of the piston groove and the piston ring.

From the moment M₅ in the anti-clockwise sense there results, on the one hand, the engine-generated displacement of the effective vertex in the direction of the combustion chamber and on the other hand, the lifting of the wiper edge from the cylinder wall. As a result, the oil stripping action of the piston ring is reduced, and the remaining non-stripped oil film becomes thicker. Oil remaining in the combustion chamber during the combustion cycle is burnt, which leads to the result that the oil consumption increases and the exhaust gas parameters deteriorate.

In summary, the disadvantages of the conventional piston ring therefore consist in a higher loading on the piston ring, increased wear and increased oil consumption.

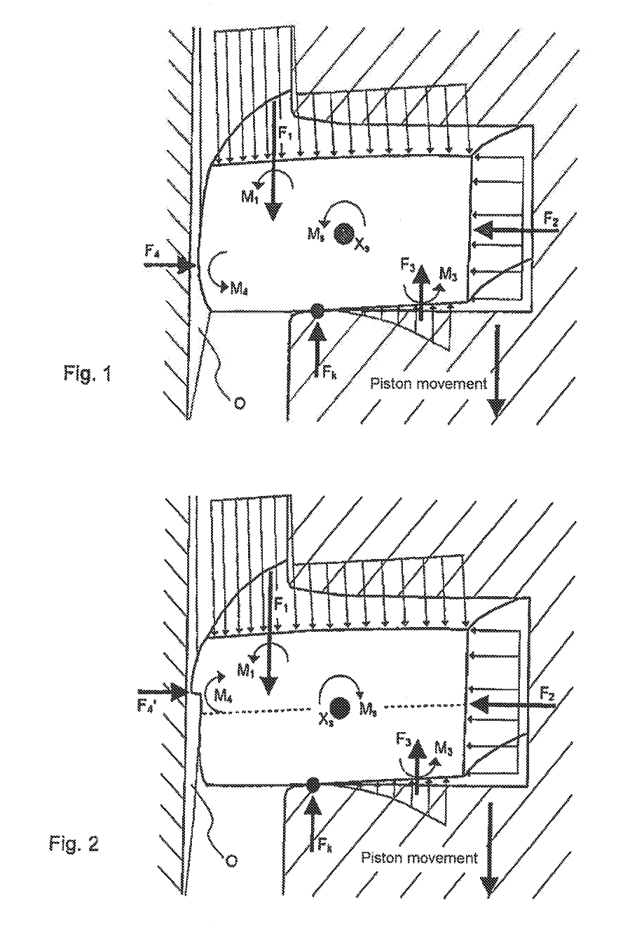

FIG. 2 shows a first embodiment of a piston ring in accordance with the invention in a cross-sectional view. By means of the inventive specific displacement of the vertex point or pivot point position in the direction of the upper annular flank (top flank), a reduction of the loading on the lower flank of the piston ring on the outer diameter is achieved. Here the pivot point is located above the centre of the running face.

As in the conventional piston ring of FIG. 1, the force F₁ continues to impact mainly on the outer diameter of the piston ring, and generates the moment. M₁ in the anti-clockwise sense. Likewise, the gas force F₂ is applied here at the centre of the ring inner face, in the same way as the gas force F₃ is applied at the lower ring inner diameter.

In contrast to the situation in FIG. 1, however, here the counter-force F₄ is applied above the centre of the running face, owing to the displacement of the pivot point into the upper half of the piston ring. This results in a moment M_{5U} about the centroid X₅ in a clockwise direction. As a result—owing to the reduction of the reaction force Fₖ—the wear on the lower piston ring flank and on the adjacent lower piston ring groove is reduced.

Furthermore, the stripping edge of the piston ring is thus prevented from lifting off the cylinder inner face and reducing the oil stripping action. In contrast to the conventional piston rind with a rotation in the anti-clockwise sense the oil consumption is therefore reduced over the running time.

However, since the oil stripping edge of the piston ring does not lift off from the cylinder inner face, hydrodynamic pressure could be built up owing to the accumulation of oil O on the stripping edge (see situation in FIG. 1), which in turn would cause a moment in the anti-clockwise sense. In accordance with the invention, a specific shaping is therefore provided in order to avoid this effect. In the case of the piston ring in accordance with the invention, a circumferential recess is provided in the lower region of the running face, as can be seen in FIG. 2.

Since, however, this would increasingly lead to the passage of blow-by gases at the joint, in accordance with the invention this recess already runs out ahead of the joint, or converts into a conventional, non-recessed shape up to the joint. This is shown in the following figures.

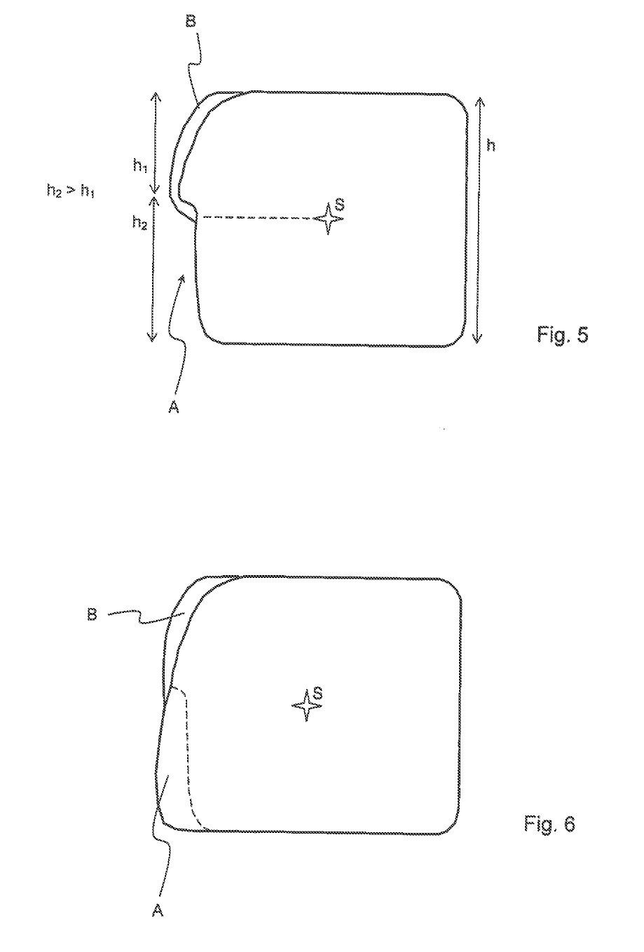

FIG. 3 shows a first region of a piston ring in accordance with the invention in cross-section; here this takes the form of a region outside the joint region, for example the ring rear region opposite the joint. A recess A is provided in this region. In this case, the recess A should have a dimension of 20 to 40% of the axial ring height on the running face. However, values of 10 to 60% are also possible. On the running surface is a galvanically or physically deposited coating B (which is not shown separately in FIG. 2). In this embodiment the vertex itself is not covered by the coating, but in alternative embodiments (see, for example, FIGS. 5 and 6), the coating may also extend over the vertex.

Ideally, the vertex (at which F₄ is applied) should be in a range of height h₂ of 60 to 70% of the axial ring height h (h₂=60 to 70% of h), but a range of 55 to 80% is also possible, especially for ring heights greater than 3 mm. The vertex is thus located above the centroid S.

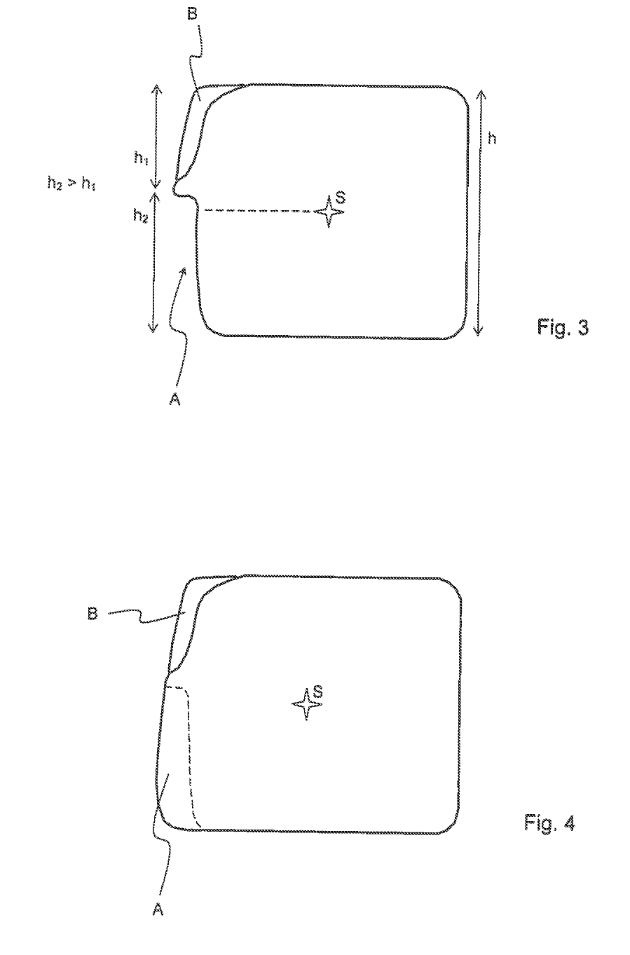

FIG. 4 shows a second region of a piston ring in accordance with the invention in cross-section. This is a region in the joint region, in order to minimise the escape of blow-by gases, the recess A (shown here in dashed lines) has already run out before the joint region, that is to say, the cross-section of the piston ring shown is brought up to the joint region in a conventional, non-recessed shape.

FIGS. 5 and 6 show an alternative embodiment to that shown in FIGS. 3 and 4. In a deviation from the latter, the vertex in this embodiment is covered by the coating, i.e. the vertex lies in the coating or the contact with the cylinder running surface is made via the coating, whereas in the embodiment in FIGS. 3 and 4 at the vertex the exposed body is in contact with the cylinder running surface.

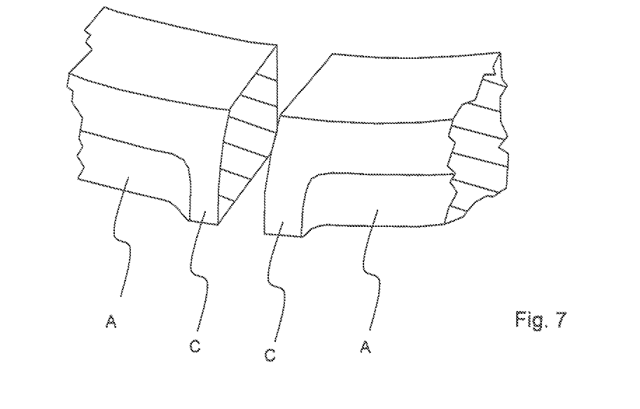

FIG. 7 shows in a plan view onto the joint region of a piston ring in accordance with the invention, how the run out of the recess can be designed in one embodiment. In accordance with the invention at the joint itself, and in an immediately adjacent region C, no recess is present in the lower running surface region. The recess only begins at a distance from the joint. In a transition region between the joint region and the completely recessed region, the depth increases or decreases in a continuous profile, the steepness and/or roundness of which can be designed in accordance with the requirements.

1. A piston ring for a reciprocating internal combustion engine, comprising:
an annular body with an open joint, a radially-outer running face, a radially-inner circumferential face and two axially opposing flank faces;
an at least partial coating on the running face; and
a circumferential recess in a lower region of the running face, which ends ahead of the joint region; wherein
the running face has a crowned profile with a pivot point that is arranged at a height h2 of 55-80% of the axial height of the piston ring, and is located in an upper half of the piston ring, and wherein
the recess on the running face has a dimension of 20 to 40% of the axial height of the piston ring, and defines the lower region of the running face and the piston ring.

2. The piston ring in accordance with claim 1, wherein the joint region extends over a range of 0.003-0.2% of the circumferential length of the piston ring, in each case from the joint.

3. The piston ring in accordance with claim 1, wherein the pivot point of the crowned running face profile is arranged at 60-70% of the axial height of the piston ring.

4. The piston ring in accordance with claim 1, wherein the radially-inner circumferential face has an essentially symmetrical profile with respect to the axial centre.

5. The piston ring in accordance with claim 1, wherein the axial height of the ring is at least 3 mm.

6. The piston ring in accordance with claim 1, wherein the radial depth of the recess runs out ahead of the joint region.

7. The piston ring in accordance with claim 1, wherein the coating on the running face covers or reveals the pivot point.
